(19) United States
(12) Patent Application Publication
(10) Pub. No.: US 2025/0329051 A1
(43) Pub. Date: Oct. 23, 2025

(54) THERMAL IMAGE-BASED TRACKING TO MATE CONNECTORS OF VEHICLES

(71) Applicant: THE BOEING COMPANY, Arlington, VA (US)

(72) Inventors: Ryan P. McClintock, Brentwood, MO (US); Caleb G. Price, Brentwood, MO (US); Christian Louis Carini, St. Louis, MO (US)

(21) Appl. No.: 18/802,820

(22) Filed: Aug. 13, 2024

Related U.S. Application Data
(60) Provisional application No. 63/637,716, filed on Apr. 23, 2024.

(51) Int. Cl. G06T 7/77; B64D 39/00; G06T 7/60

(52) U.S. Cl. CPC G06T 7/77; G06T 7/60; B64D 39/00; G06T 2207/10048; G06T 2207/30252

(57) ABSTRACT

A device includes a thermal imaging sensor configured to generate a thermal image depicting a drogue attached to a vehicle. The device includes a vision processor coupled to the thermal imaging sensor. The vision processor is configured to process the thermal image to obtain multiple candidate locations of the drogue in the thermal image and one or more scores associated with each of the candidate locations. The device also includes a second processor configured to process the candidate locations and the one or more scores associated with each of the candidate locations to generate a tracked position of the drogue.

### CROSS-REFERENCE TO RELATED APPLICATIONS

The present application claims the benefit of U.S. Provisional Patent Application No. 63/637,716 entitled “THERMAL IMAGE-BASED TRACKING TO MATE CONNECTORS OF VEHICLES,” filed Apr. 23, 2024, the contents of which are incorporated herein by reference in their entirety.

### FIELD OF THE DISCLOSURE

The present disclosure is generally related to thermal image-based tracking to mate connectors of vehicles.

### BACKGROUND

Highly skilled human operators are typically used to guide complex, high-speed docking operations, such as air-to-air refueling and spacecraft docking operations. As such, the operations rely heavily on human judgment, which is sometimes supplemented by computer vision techniques. To illustrate, complex stereoscopic vision systems may be used to aid the human operator in mating connectors (e.g., a receiver and refueling boom or docking connectors). These docking operations can be complex and involve precision maneuvers, making such operations difficult to extend to autonomous vehicles such as drones, drone aircraft, or autonomous spacecraft. Additionally, artificial intelligence-based solutions can be challenging to test, resulting in difficulty certifying such systems with industry organizations or governments.

### SUMMARY

In a particular implementation, a device includes a thermal imaging sensor configured to generate a thermal image depicting a drogue attached to a vehicle. The device includes a vision processor coupled to the thermal imaging sensor, wherein the vision processor is configured to process the thermal image to obtain multiple candidate locations of the drogue in the thermal image and one or more scores associated with each of the candidate locations. The device also includes a second processor configured to process the candidate locations and the one or more scores associated with each of the candidate locations to generate a tracked position of the drogue.

In another particular implementation, a method includes processing, at a vision processor, a thermal image depicting a drogue attached to a vehicle to obtain multiple candidate locations of the drogue in the thermal image and one or more scores associated with each of the candidate locations. The method includes processing, at a second processor, the candidate locations and the one or more scores associated with each of the candidate locations to generate a tracked position of the drogue.

In another particular implementation, a non-transitory, computer-readable medium stores instructions that, when executed by one or more processors that include a vision processor and a second processor, cause the one or more processors to perform operations that include receiving, at the vision processor, a thermal image depicting a drogue attached to a vehicle and processing, at the vision processor, the thermal image to obtain multiple candidate locations of the drogue in the thermal image and one or more scores associated with each of the candidate locations. The operations also include processing, at the second processor, the candidate locations and the one or more scores associated with each of the candidate locations to generate a tracked position of the drogue.

The features, functions, and advantages described herein can be achieved independently in various implementations or may be combined in yet other implementations, further details of which can be found with reference to the following description and drawings.

### BRIEF DESCRIPTION OF THE DRAWINGS

FIGS. 1A-1E illustrate examples of a system configured to perform thermal image-based tracking to mate connectors of vehicles.

FIG. 2 is a diagram that illustrates an example of a system configured to perform thermal image-based tracking to mate connectors of vehicles.

FIG. 3 is a diagram that illustrates an example of a system configured to perform thermal image-based tracking to mate connectors of vehicles.

FIGS. 4A-4C depict examples of images and histograms associated with operations that can be used to perform thermal image-based tracking to mate connectors of vehicles.

FIG. 5 is a flowchart illustrating an example of a method of performing thermal image-based tracking to mate connectors of vehicles.

FIG. 6 is a flowchart illustrating an example of a life cycle of an aircraft including a vision system configured to perform thermal image-based tracking to mate connectors of vehicles.

FIG. 7 is a block diagram of a particular implementation of the aircraft associated with the life cycle of FIG. 6.

FIG. 8 is a block diagram of a computing environment including a computing device configured to support aspects of computer-implemented methods and computer-executable program instructions (or code) according to the present disclosure.

### DETAILED DESCRIPTION

Aspects disclosed herein present systems and methods of thermal image-based detection of a location or an estimated location of a connector of a vehicle to be mated with a connector of an autonomous or semi-autonomous vehicle. For example, a vision processor that resides onboard a first aircraft, such as a drone aircraft, another type of autonomous aircraft or semi-autonomous aircraft (e.g., an aircraft that implements an autonomous aerial refueling receive (A2R2) capability), or an autonomous or semi-autonomous spacecraft, can process thermal image data from a thermal imaging sensor, such as an infrared camera, to detect or identify a second connector of a second aircraft depicted in the thermal image data. The second aircraft may include an aircraft or spacecraft, another autonomous or semi-autonomous aircraft, or an autonomous or semi-autonomous spacecraft, such as a refueling tanker, that includes the second connector with which a first connector of the first aircraft is configured to mate. In implementations described herein, the first connector includes a probe, a fuel receptacle, a docking appendage, or the like, and the second connector includes a drogue, a drogue basket, a refueling boom, a docking clamp or receptacle, or the like. In some implementations, the vision processor outputs an indication of a location or an estimated location of the second connector (or a portion thereof) to one or more other processor(s), such as a guidance processor of a navigation system, to enable the guidance processor to determine and initiate the performance of maneuvers to guide the first aircraft to mate the first connector (e.g., the probe) to the second connector (e.g., the drogue). As an example, the location and/or the estimated location output by the vision processor can enable the guidance processor to maneuver the first aircraft such that a refueling connector (e.g., the probe) is mated to a refueling port (e.g., the drogue) of the second aircraft during air-to-air refueling operations. As another example, the location or the estimated location output by the vision processor can enable the guidance processor to maneuver the first vehicle such that one spacecraft is docked to another spacecraft (e.g., via mating the first and second connectors). In implementations, the vision processor is used to support the guidance processor instead of using a human operator to reduce costs, such as costs associated with training human operators and costs associated with operations to mate connectors.

In some contexts, the two aircraft performing mating (e.g., of connectors) include a primary aircraft and a secondary aircraft. Although the terms may be arbitrarily assigned in some contexts (such as where two peer aircraft are mating), generally, the primary aircraft refers to an aircraft that is connecting to the secondary aircraft to be serviced by the secondary aircraft, or the primary aircraft refers to the aircraft, onboard which the vision processor resides. To illustrate, in an air-to-air refueling context, the primary aircraft is the receiving aircraft (e.g., the aircraft to be refueled). Likewise, the secondary aircraft refers to the other aircraft of a pair of aircraft. To illustrate, in the air-to-air refueling context, the secondary aircraft is the tanker aircraft. Although predominately referred to herein as aircraft, the first aircraft and the second aircraft can also be referred to as a first device and a second device, with the term device used broadly to include an object, system, or assembly of components that is/are operated upon as a unit (e.g., in the case of the secondary device) or that operate cooperatively to achieve a task (e.g., in the case of the primary device).

In a particular aspect, the first aircraft uses a vision processor to obtain, based on thermal image data of an image associated with the second connector (e.g., a drogue), multiple candidate locations associated with the second connector. For example, the vision processor obtains, from a thermal imaging sensor, a thermal image depicting a drogue (e.g., a drogue basket) attached to a vehicle and processes the thermal image to obtain multiple candidate locations of the drogue in the thermal image, in addition to obtaining one or more scores associated with each of the candidate locations. A second processor processes the candidate locations and the one or more scores associated with each of the candidate locations to generate a tracked position of the drogue.

According to an aspect, the vision processor generates multiple sets of candidate locations using different image processing techniques. For example, a first set of the candidate locations can be based on a first image processing operation and a second set of the candidate locations can be based on a second image processing operation that is distinct from the first image processing operation. To illustrate, the first image processing operation can includes at least one of a gradient-based circle detection of an outer edge of the drogue basket, a gradient-based spoke detection of inner spokes of the drogue basket, or a transform-based template matching detection of the drogue basket, and the second image processing operation can include another of the gradient-based circle detection of the outer edge of the drogue basket, the gradient-based spoke detection of the inner spokes of the drogue basket, or the transform-based template matching detection of the drogue basket.

One benefit of the disclosed systems and methods is that the vision processor and the thermal imaging sensor provide an all-optical, passive solution for mating connectors of vehicles during flight, such as for aerial refueling of aircraft or docking of spacecraft, which provides a high confidence solution at close range. For example, by obtaining candidate locations and scores (e.g., confidence scores and sub-scores) for each of the candidate locations that are generated using multiple independent or semi-independent detection techniques, the second processor can achieve more robust tracking than is possible using only a single one of the detectors. By avoiding artificial intelligence-based solutions and segregating track state management to a second computer environment operating at a higher level of rigor, the present techniques provide a certifiable solution for autonomism aerial refueling receive while avoiding many of the pitfalls that could cause an otherwise functional system to fail to meet various certification criteria for close-formation manned/unmanned flight.

The systems and methods disclosed herein can provide autonomous mating of connectors between aircraft in situations in which global positioning satellite (GPS)-based systems and/or inertial navigation system (INS)-based solutions are inoperable or have lower reliability, or in aircraft that do not include an onboard GPS or INS system, without significantly increasing cost or complexity of the systems onboard the autonomous or semi-autonomous aircraft. Additionally, or alternatively, the candidate locations provided by the vision processor can be combined with (e.g., by using as a safety check or verification for) other object recognition operations and/or for a GPS-based or INS-based solution to provide a holistic refueling or docking system with high reliability and confidence. Further, using vision-based maneuvering to control aircraft or spacecraft during complicated maneuvers, such as aerial refueling or docking, can reduce costs and resources as compared to training human operators to control the aircraft, as well as providing more predictable and repeatable maneuvers than using human operators.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, a system may be described herein as including one or more computing devices (“computing device(s)”), which indicates that in some implementations the system includes a single computing device and in other implementations the system includes multiple computing devices. For ease of reference herein, such features are generally introduced as “one or more” features, and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent; and the term “approximately” may be substituted with “within 10 percent of” what is specified. The statement “substantially X to Y” has the same meaning as “substantially X to substantially Y.” unless indicated otherwise. Likewise, the statement “substantially X, Y, or substantially Z” has the same meaning as “substantially X, substantially Y, or substantially Z.” unless indicated otherwise.

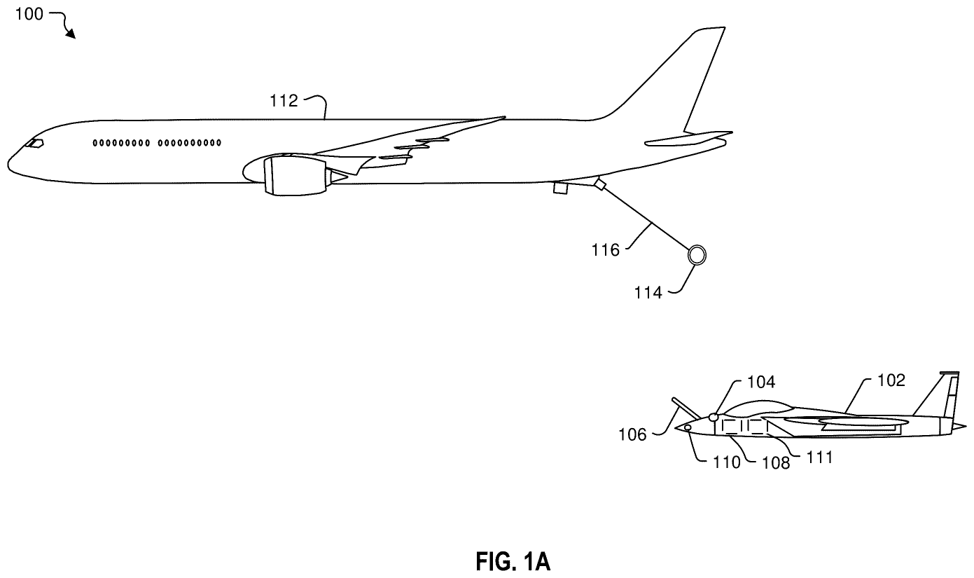

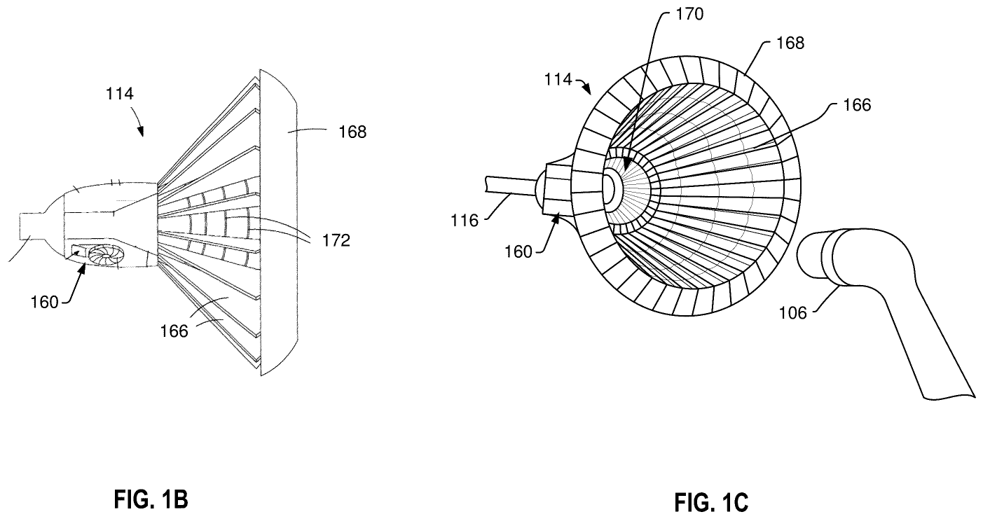

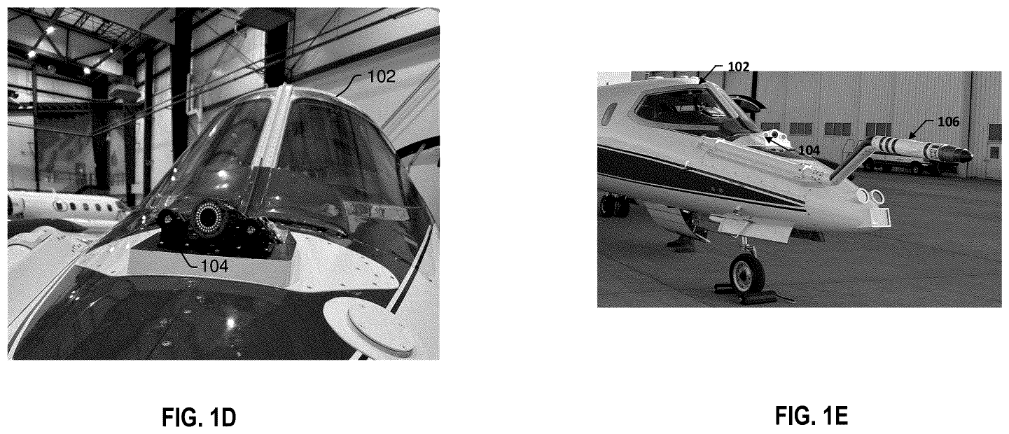

FIGS. 1A-1E illustrate an example of a system 100 for identifying a location of a drogue according to one or more aspects of the present disclosure. FIG. 1A is a diagram that illustrates the system 100 including several aircraft including a first aircraft 102 and a second aircraft 112. FIG. 1B is a diagram of a side-view of an example of a drogue 114 of the second aircraft 112. FIG. 1C is a diagram of an example of the drogue 114 and a probe 106 of the first aircraft 102. FIGS. 1D and 1E are each an image of an example of a first aircraft 102.

Referring to FIG. 1A, the system 100 includes the first aircraft 102 and the second aircraft 112. The first aircraft 102 is configured to identify or estimate a location of a drogue 114 (e.g., a basket) of the second aircraft 112. For example, the first aircraft 102 can detect or estimate a location of the drogue 114 based on thermal image data. Detection or estimation of the location of the drogue 114 can enable the first aircraft 102 to identify or track the drogue 114. In some implementations, detection of the location of the drogue 114 can enable the first aircraft 102 to perform one or more maneuvers to mate the probe 106 (also referred to as a first connector) of the first aircraft 102 with the drogue 114, also referred to as a second connector, of the second aircraft 112.

In the example illustrated in FIG. 1A, the first aircraft 102 includes or corresponds to an autonomous aircraft, such as a drone or drone aircraft, a semi-autonomous aircraft (e.g., an aircraft that supports an A2R2 capability), an autonomous or semi-autonomous spacecraft, or the like (a primary device, as described above), as described above, and the second aircraft 112 includes or corresponds to a fuel tanker (a secondary device, as described above). For example, the second aircraft 112 can be configured to service or support the first aircraft 102, such as providing fuel or a refueling service, and the first aircraft 102 includes a device or system configured to couple to the second aircraft 112 and possibly to be serviced by or supported by the second aircraft 112. Although described in the context of a fuel tanker and an autonomous or semi-autonomous aircraft, in other implementations, the first aircraft 102 can include other types of aircraft or spacecraft, such as a space shuttle, and the second aircraft 112 can include other types of aircraft of spacecraft, such as a space station with which the first aircraft 102 is configured to dock.

The second aircraft 112 is coupled via a hose 116 to the drogue 114. The first aircraft 102 includes the probe 106 that is configured to couple with (e.g., physically attach to) the drogue 114. The second aircraft 112 is configured to provide fuel via the hose 116 to the first aircraft 102 while the probe 106 is coupled to the drogue 114. Although the drogue 114 is illustrated in FIG. 1A as being coupled to the second aircraft 112 via the hose 116, in some other implementations, the second aircraft 112 includes a moveable coupling system configured to move the drogue 114 (or another type of connector) relative to the probe 106 (or another type of connector) of the first aircraft 102. For example, the moveable coupling system of the second aircraft 112 can include a steerable boom (e.g., a refueling boom) of a refueling system or a steerable docking arm of a docking system. The above referenced examples are merely illustrative and are not limiting. Additionally, the second aircraft 112 includes a fuel tank to supply fuel, via the hose 116 (or a refueling boom), to the first aircraft 102.

Referring to FIGS. 1B and 1C, the drogue 114 includes a reception coupling 160 and an array of structures 166 (also referred to herein as arms or spokes) extending therefrom and which support a canopy 168 at the distal ends thereof. The reception coupling 160 includes an internal passage 170 (e.g., a socket) for receiving a refueling probe (e.g., the probe 106) and is attached to a fuel hose (e.g., the hose 116). The structures 166 surround the entrance to the internal passage 170 and may each be joined to adjacent arms by tie wires 172 for avoiding penetration between the structures 166 by the probe 106. The structures 166 may each have a planar (or substantially planar) body portion, extending radially from an opening/center of the internal passage 170 (e.g., socket) the drogue 114.

Referring to FIGS. 1A, 1D, and 1E, the first aircraft 102 includes a thermal imaging sensor 104. In an example, the thermal imaging sensor 104 includes a long-wave infrared (LWIR) camera or another type of infrared (IR) camera. The thermal imaging sensor 104 is configured to generate thermal image data (e.g., thermal image(s)) that depicts temperature information associated with at least a portion of the drogue 114, at least a portion of the second aircraft 112, or a combination thereof. For example, the LWIR camera can be configured to generate thermal image data based on wavelengths ranging from 8 μm to 14 μm. In some implementations, the thermal image data represents a stream of real-time (e.g., subject to only minor video front-end processing delays and buffering) thermal image frames that represent relative temperatures and relative positions of at least a portion of the drogue 114, at least a portion of the second aircraft 112, or a combination thereof. In a particular aspect, the thermal imaging sensor 104 is located within a housing that is coupled to a hull of the first aircraft 102 and that includes an aperture that provides a field of view for thermal imaging sensor 104. Alternatively, the thermal imaging sensor 104 can be located at or near an end of the probe 106. In some implementations, the first aircraft 102 includes multiple thermal imaging sensors 104 positioned at one or more locations with respect to the hull, the probe 106, or a combination thereof.

Referring to FIG. 1A, the first aircraft 102 also includes a vision processor 108, an optional memory (not shown in FIGS. 1A-1E), one or more additional processors 111, and optionally, one or more sensors 110. In the example illustrated in FIGS. 1A-1E, the vision processor 108 includes or corresponds to one or more image processors. In examples, the additional processor(s) 111 include or correspond to one or more guidance processors, one or more navigational processors, one or more processors of a flight control system, other types of processors, or a combination thereof. In some implementations, the vision processor 108 and the additional processor(s) 111 are combined. To illustrate, one or more graphics processing units (GPUs), one or more central processing units (CPUs), one or more field programmable gate arrays (FPGAs), one or more digital signal processors (DSPs), or one or more other multi-core or multi-thread processing units may serve as both the vision processor 108 and the additional processor(s) 111. Although some implementations include the memory, in other implementations, the memory is omitted from the first aircraft 102.

The sensor(s) 110, when present, are configured to generate supplemental sensor data (e.g., additional image and/or position data) indicative of relative positions of the first aircraft 102 and the second aircraft 112. For example, the sensor(s) 110 may include a camera, a video capture device, a light emitting diode (LED) device, position sensors (e.g., gyroscope(s), accelerometer(s), inertial navigation system (INS) sensors, and the like), and sensor data generated by the sensor(s) 110 can include additional image data, video data, position data, such as 6 degrees of freedom (6DoF) position data, INS data, or a combination thereof. Additionally, or alternatively, the sensor(s) 110 may include an outside air temperature sensor that can be used to estimate the expected temperature range for the drogue 114. Additionally, or alternatively, the sensor(s) 110 may include a range finder (e.g., a laser range finder and/or a radio with ranging capability, such as a tactical radio), and the sensor data generated by the sensor(s) 110 can include range data (e.g., a distance from the range finder to the second aircraft 112). Additionally, or alternatively, the sensor(s) 110 may include a radar system, and the sensor data generated by the sensor(s) 110 may include radar data (e.g., radar returns indicating a distance to the second aircraft 112, a direction to the second aircraft 112, or both). Additionally, or alternatively, the sensor(s) 110 may include a light detection and ranging (lidar) system, and the sensor data generated by the sensor(s) 110 may include lidar data (e.g., lidar returns data indicating a distance to the second aircraft 112, a direction to the second aircraft 112, or both). Additionally, or alternatively, the sensor(s) 110 may include a sonar system, and the sensor data generated by the sensor(s) 110 may include sonar data (e.g., sonar returns indicating a distance to the second aircraft 112, a direction to the second aircraft 112, or both). Additionally, or alternatively, the sensor(s) 110 may include one or more additional cameras (e.g., in addition to the thermal imaging sensor 104), and the sensor data generated by the sensor(s) 110 may include stereoscopic image data.

During operation, the first aircraft 102 can activate the thermal imaging sensor 104 to capture thermal image data representing at least a portion of the second aircraft 112, at least a portion of the drogue 114, or a combination thereof. In implementations that include the sensor(s) 110, the sensor(s) 110 can capture additional sensor data associated with the second aircraft 112, the drogue 114, or both. The vision processor 108 processes the thermal image data to detect a location (e.g., an estimated location) of the drogue 114, or a portion thereof. The vision processor 108 provides information associated with the location or the estimated location of the drogue 114 to the additional processor(s) 111. In some implementations, the vision processor 108 processes the additional sensor data to detect a location (e.g., an estimated location) of the drogue 114, or a portion thereof, using other techniques and the additional sensor data, and the vision processor 108 provides information associated with the location or the estimated location detected based on the additional sensor data to the additional processor(s) 111. In this example, the vision processor 108 can provide scores (e.g., confidence scores) associated with the location, estimated location, or a combination thereof, to the additional processor(s) 111. The additional processor(s) 111 can determine navigation for the first aircraft 102 and/or maneuver the first aircraft 102, the probe 106, or both, based on the location and/or the estimated location, to engage the probe 106 with the drogue 114 to initiate refueling of the first aircraft 102.

Although FIGS. 1A-1E depict the first aircraft 102 including the sensor(s) 110, in some implementations the sensor(s) 110 are omitted or are not used to generate input to the additional processor(s) 111. For example, a location and/or an estimated location (e.g., of the drogue 114 or a portion thereof) may be determined solely based on thermal image data output by the thermal imaging sensor 104. Additionally, or alternatively, the vision processor 108 can perform one or more additional operations to identify or track the second aircraft 112 and/or the drogue 114, such as by using the sensor(s) 110.

The thermal imaging sensor 104 and the vision processor 108, in conjunction with other features of the first aircraft 102, improves efficiency (e.g., by reducing training costs), reliability, and repeatability of operations to mate the probe 106 and the drogue 114. For example, the vision processor 108 can process thermal image data generated by the thermal imaging sensor 104 to detect the location (e.g., the estimated location) of the drogue 114, or a portion thereof, without the cost and complexity of integrating other types of sensors in the first aircraft 102. Additionally, or alternatively, the location or the estimated location detected by the vision processor 108 can be used to support operations or functionality of other systems of the first aircraft 102, thereby improving the reliability and increasing confidence in detection and/or identification of the drogue 114 or a portion thereof. Such highly reliable detection is provided without significantly increasing the cost or complexity of the first aircraft 102, as the thermal imaging sensor 104 and the vision processor 108 represent a relatively small and low-cost portion of the overall processing resources and sensors onboard the first aircraft 102. The detection of the location of the drogue 114 or a portion thereof may be provided to the additional processor(s) 111, such as a guidance processor, which can mimic maneuvers performed by highly skilled human operators without the time and cost required to train the operators. Further, damage caused by improper maneuvers performed by automated aircraft or spacecraft can be reduced or eliminated by performing maneuvers that are determined based on the location or the estimated location of the drogue 114 (or a portion thereof) output by the vision processor 108.

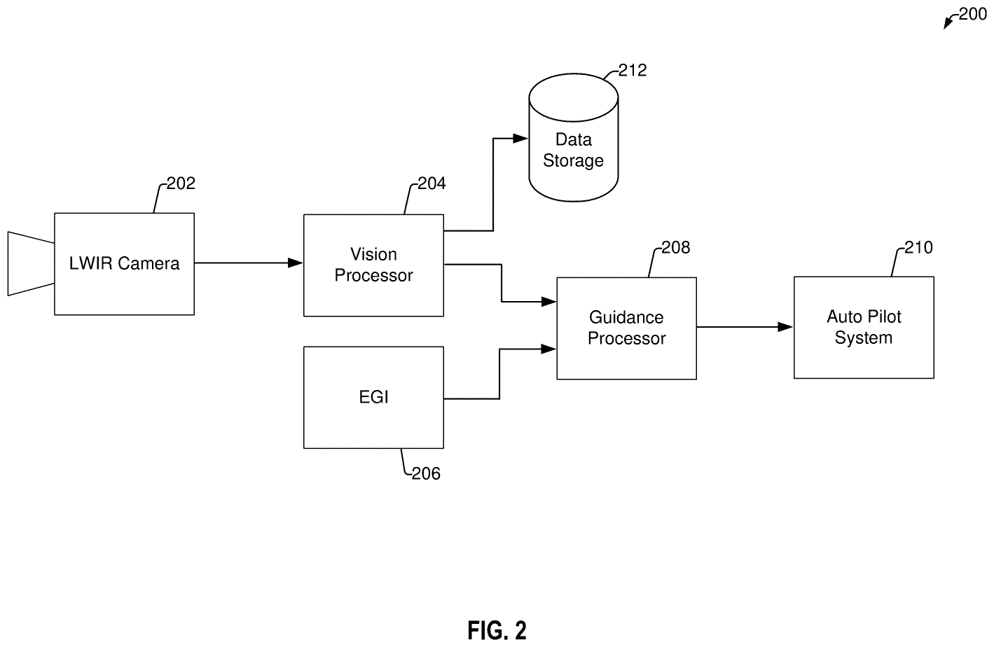

FIG. 2 is a diagram that illustrates a system 200 that is configured to perform thermal image-based tracking to mate connectors of vehicles. The system 200 is included in one or more devices, such as an autonomous or semi-autonomous aircraft or an autonomous or semi-autonomous spacecraft. As an example, the system 200 can be included in or correspond to the first aircraft 102 of FIGS. 1A, 1D, and 1E. In the implementation shown in FIG. 2, the system 200 includes an LWIR camera 202, a vision processor 204, an optional embedded GPS-aided inertial navigation system (EGI) 206, a guidance processor 208, an auto pilot system 210, and optional data storage 212. The LWIR camera 202 is coupled to the vision processor 204, the vision processor 204 is coupled to the guidance processor 208 and the data storage 212, the EGI 206 is coupled to the guidance processor 208, and the guidance processor 208 is coupled to the vision processor 204, the EGI 206, and the auto pilot system 210. Although illustrated as being included in the system 200 in FIG. 2, in some other implementations, the EGI 206 is omitted from the system 200.

The LWIR camera 202 may include or correspond to the thermal imaging sensor 104. In some implementations, the LWIR camera 202 is configured to capture thermal images within a field of vision and to output thermal image data representing the thermal images to the vision processor 204. The thermal image data can depict temperature information of a captured scene, such as a portion of another aircraft or spacecraft that is within a particular range of the aircraft on which the system 200 is onboard. Although described as a LWIR camera, in other implementations, the LWIR camera 202 may additionally include, or be replaced with, any type of IR image capture device or thermal imaging device. Additionally, or alternatively, one or more other cameras, image capture devices, LED devices, or the like, may be similarly coupled to the vision processor 204 and configured to output respective image data or other types of data for use by the vision processor 204.

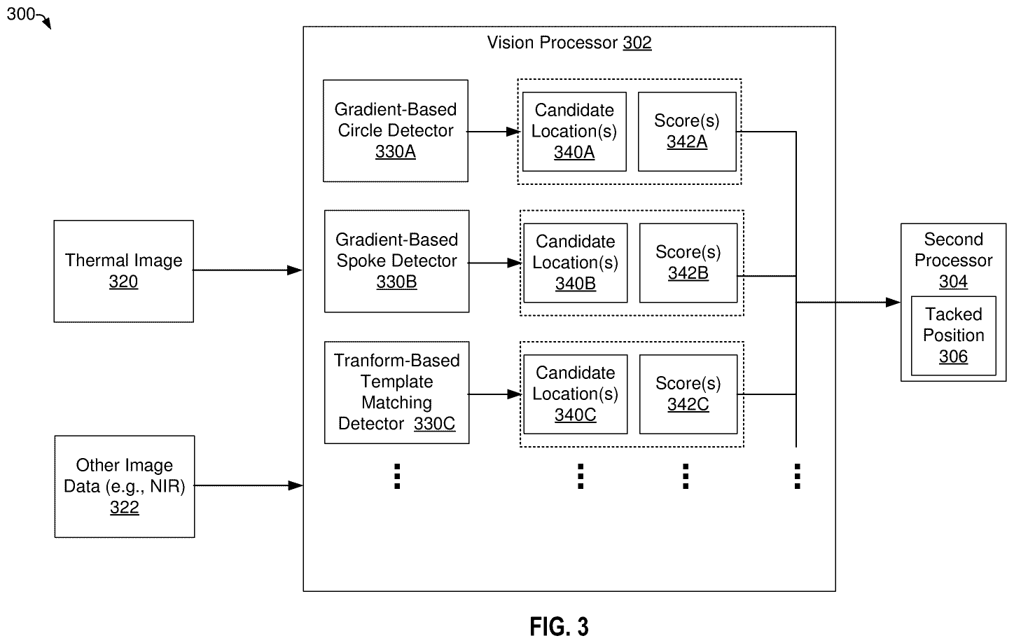

The vision processor 204 includes one or more processors, processor systems, CPUs, GPUs, DSPs, and/or other hardware or circuitry, such as field-programmable gate arrays (FPGAs) or application-specific integrated circuits (ASICs), that are configured to process the thermal image data from the LWIR camera 202 (and optionally other data from other sensors) to identify and track another aircraft or spacecraft (or a pose thereof) within a series of thermal images represented by the thermal image data. For example, the vision processor 204 can include or correspond to the vision processor 108. As described further herein with reference to FIGS. 3-5, the vision processor 204 can perform thermal image data processing/image processing to detect or identify a location or an estimated location of the drogue 114, or a portion thereof. Additionally, or alternatively, the vision processor 204 can process the thermal imaging data and or other data to identify, track, and/or determine a location or estimated location of position of a connector of the other aircraft, using other techniques described. In implementations in which the vision processor 204 determines multiple locations or estimated locations, other derived values, and/or other processed thermal image data, each such value or estimation may be associated with a confidence score generated by the vision processor 204. The vision processor 204 provides the estimates, derived values, and/or processed thermal image data, and optionally the confidence scores, to a second processor, such as the guidance processor 208, for further processing and, optionally, to the data storage 212. Additionally, or alternatively, the data storage 212 may be configured to store dimension information associated with the drogue 114, such as a size of the drogue 114 (e.g., an aerial refueling basket). For example, the size may be a radius of the drogue 114.

The guidance processor 208, the EGI 206, or both, may include or correspond to the additional processor(s) 111. The guidance processor 208 includes one or more processors, processor systems, CPUs, GPUs, DSPs, and/or other hardware or circuitry, such as FPGAs or ASICs, that are configured to process the output of the vision processor 204 and optional GPS and INS data received from the EGI 206 to determine one or more maneuvers to be performed by the aircraft on which the system 200 is onboard to cause the aircraft to mate a connector (e.g., the probe 106) with a connector (e.g., the drogue 114) of the other aircraft (e.g., the aircraft depicted in the thermal imaging data output by the LWIR camera 202). The maneuvers can include navigation directions for the aircraft, movements for a probe or other arm or boom that controls the connector for the aircraft, engine control instructions, other maneuver-related information, or a combination thereof, that when executed by the auto pilot system 210, cause the aircraft to approach the other aircraft, maintain formation flight with the other aircraft, and/or mate the connector to the corresponding connector of the other aircraft, such as during an aerial refueling operation or a docking operation between spacecraft. As a non-limiting example, the guidance processor 208 may output instructions to the auto pilot system 210 to cause the first aircraft 102 to mate the probe 106 with the drogue 114 of the second aircraft 112.

In implementations that include the data storage 212, the vision processor 204 can be configured to provide the various output (e.g., range estimate(s), position estimate(s), tracking information, processed thermal image data, etc.) to the data storage 212 for storage on the aircraft and/or transmission to another system or device. For example, the data storage 212 can include network or cloud storage that is wireless connected to the system 200 at various times. The output data from the vision processor 204 (the “vision output data”) may be used to train one or more artificial intelligence (AI) or machine learning (ML) models to automatically perform operations associated with the vision processor 204, the guidance processor 208, or a combination thereof. To illustrate, the vision output data can be provided as training data to an autonomous agent (e.g., an AI or ML model) to train the autonomous agent to estimate a range to another aircraft based on input thermal imaging data. In a particular aspect, the thresholded image data (or features extracted therefrom) can be labeled with corresponding pose estimates, range estimates, corresponding confidence scores, other intermediate values, or a combination thereof, to train the autonomous agent to estimate a pose or range based on non-labeled thermal image data received as input. In another aspect, the thresholded image data (or features extracted therefrom) can be labeled with one or more maneuvers output by the guidance processor 208 to train the autonomous agent to, responsive to receiving unlabeled thermal image data, output maneuver instructions to cause the aircraft to mate the connector with the connector of the other aircraft.

In a particular implementation, the trained autonomous agent includes or corresponds to a neural network. As an example, the neural network of the trained autonomous agent is trained using one or more reinforcement learning techniques. To illustrate, during a training phase, the reinforcement learning techniques may train the neural network based in part on a reward that is determined by comparing a proposed maneuver output by the neural network to an optimum or target maneuver in particular circumstances. In this context, the optimum or target maneuver may include, for example, a shortest or least cost maneuver to mate the connectors of the aircrafts; a maneuver that mimics a maneuver performed by one or more skilled human operators under similar circumstances; a maneuver that satisfies a set of safety conditions, such as not causing any undesired contact between portions of the aircrafts; a maneuver that corresponds to maneuvering characteristics specified during or before training; or a combination thereof. As another example, during a training phase, the reinforcement learning techniques may train the neural network based in part on a reward that is determined by comparing a pose estimate, a range estimate, or a position estimate output by the neural network to a measured pose, a measured range, or a measured position of the other aircraft depicted in the thermal image data. As another example, during a training phase, the reinforcement learning techniques may train the neural network based in part on a reward that is determined by comparing a location or estimated location output by the neural network to a measured location or a measured position of the drogue 114 (or a portion thereof) depicted in the image and based on the thermal image data.

In some implementations, the system 200 can include a display (not shown). The display can be coupled to the LWIR camera 202, the vision processor 204, the guidance processor 208, the auto pilot system 210, or a combination thereof. The display is configured to display one or more images, a representation of one or more operations performed by the vision processor 204, one or more operations performed by guidance processor 208, one or more operations performed by the auto pilot system 210, or a combination thereof.

FIG. 3 depicts an example of a system 300 that includes a first processor, illustrated as a vision processor 302, coupled to a second processor 304 and that is used in conjunction with thermal image-based tracking to mate connectors of vehicles. According to an aspect, the vision processor 302 corresponds to the vision processor 108 of FIG. 1A or the vision processor 204 of FIG. 2, and the second processor 304 is distinct from the vision processor 204. In an example, the second processor 304 is implemented using separate hardware from the vision processor 302 and a different operating system than the vision processor 302. In some implementations, the second processor 304 corresponds to or is included in the additional processor(s) 111 of FIG. 1A or in the guidance processor 208 of FIG. 2, while in other implementations the second processor 304 is distinct from and coupled to the additional processor(s) 111 of FIG. 1 or the guidance processor 208 of FIG. 2.

The vision processor 302 is configured to obtain a thermal image 320 from a thermal imaging sensor, such as the thermal imaging sensor 104 of FIG. 1A, 1D, or 1E, or the LWIR camera 202 of FIG. 2. For example, the thermal image 320 depicts a drogue basket attached to a vehicle, such as the drogue 114 attached to the second aircraft 112. The vision processor 302 is configured to processes the thermal image 320 to obtain multiple candidate locations 340 of the drogue basket in the thermal image 320 and one or more scores 342 associated with each of the candidate locations 340.

According to an aspect, the vision processor 302 is configured to generate a first set of the candidate locations 340A based on a first image processing operation, a second set of the candidate locations 340B based on a second image processing operation that is distinct from the first image processing operation, and a third set of the candidate locations 340C based on a third image processing operation that is distinct from both the first and second image processing operations.

To illustrate, the vision processor 302 includes a gradient-based circle detector 330A that is configured to perform a gradient-based circle detection of an outer edge of the drogue basket (e.g., a Hough gradient-based circle detection of the outer basket skirt) by processing thermal image data to generate the first set of candidate locations 340A of the drogue basket (e.g., (x, y) pixel coordinates of a candidate center of the drogue basket). For example, the gradient-based circle detector 330A can identify edges by processing gradient image data that is based on the thermal image 320, determine an edge normal unit vector for each edge pixel (e.g., a unit vector in the direction of the gradient associated with the edge pixel), extend the edge normal unit vectors by an amount proportional to an expected size of the drogue basket (e.g., a radius of the drogue basket), and generate an accumulation map indicating, for each pixel, how many of the extended edge unit vectors terminate near that pixel. If the uncertainty in the size of the drogue basket exceeds 1 pixel, multiple extended edge unit vectors spanning the uncertainty can be accumulated. The gradient-based circle detector 330A can identify the largest peaks in the accumulation map as the first set of candidate locations 340A, with the largest detected peak indicating the most likely location of the center of the drogue basket. In an alternate, the accumulation map can be thresholded and blob detection can be used to estimate a centroid and weighted for each blob. In an example, the first set of candidate locations 340A can include multiple candidate locations, such as the 10-20 highest confidence candidate locations (e.g., the 10-20 largest peaks) as determined by the gradient-based circle detector 330A.

The vision processor 302 also includes a gradient-based spoke detector 330B that is configured to perform a gradient-based spoke detection of inner basket spokes of the drogue basket (e.g., a gradient-based spoke detection of the inner basket spokes 166) by processing thermal image data to generate the second set of candidate locations 340B of the drogue basket (e.g., (x, y) pixel coordinates of a candidate center of the drogue basket). For example, the gradient-based spoke detector 330B can identify edges by processing gradient image data that is based on the thermal image 320, determine an edge normal unit vector for each edge pixel (e.g., a unit vector in the direction of the gradient associated with the edge pixel), extend vectors in both directions perpendicular to the edge normal unit vector (e.g., tangential to the edge at that pixel) by an amount proportional to an expected size of the drogue basket (e.g., a radius of the drogue basket), and generate an accumulation map indicating, for each pixel, how many of the extended edge unit vectors are at least partially in that pixel. The gradient-based spoke detector 330B can identify the largest peaks in the accumulation map as the second set of candidate locations 340B, with the largest detected peak indicating the most likely location of the center of the drogue basket. In an alternate, the accumulation map can be thresholded and blob detection can be used to estimate a centroid and weighted for each blob. In an example, the second set of candidate locations 340B can include multiple candidate locations, such as the 10-20 highest confidence candidate locations (e.g., the 10-20 largest peaks) as determined by the gradient-based spoke detector 330B.

The vision processor 302 further includes a transform-based template matching detector 330C that is configured to perform a transform-based template matching/detection of the drogue basket (e.g., a fast Fourier transform (FFT)-based phase correlation template matching and/or an FFT-based convolutional template matching) by processing thermal image data to generate the third set of candidate locations 340C of the drogue basket (e.g., (x, y) pixel coordinates of a candidate center of the drogue basket). For example, the transform-based template matching detector 330C can process transform data (e.g., FFT data) that is based on the thermal image 320, such as by performing a correlation or convolution to determine how strongly one or more portions of the FFT data match a template associated with the expected drogue basket, and generate an accumulation map indicating, for each pixel location, the strength of the match associated with that pixel location. The transform-based template matching detector 330C can identify the largest peaks in the accumulation map as the third set of candidate locations 340C, with the largest detected peak indicating the most likely location of the drogue basket. In an alternate, the accumulation map can be thresholded and blob detection can be used to estimate a centroid and weighted for each blob. In an example, the third set of candidate locations 340C can include multiple candidate locations, such as the 10-20 highest confidence candidate locations (e.g., the 10-20 largest peaks) as determined by the transform-based template matching detector 330C.

Each of the detectors 330 outputs the respective set of candidate locations 340 and, for each of the candidate locations 340 in the detector's respective set of candidate locations 340, one or more scores 342 associated with that candidate location. For example, the score(s) 342A for each particular candidate location 340 detected by the gradient-based circle detector 330A can include an intensity (e.g., accumulator map peak height) of that candidate location in the accumulation map generated by the gradient-based circle detector 330A. The score(s) 342A can also include sub-scores (e.g., parametric scores, or meta-scoring) associated with the respective candidate location. To illustrate, in addition to the accumulator map peak height corresponding to a confidence value of a candidate location, the score(s) 342A can also include blob scoring parameters (e.g., weight, count, radius, asymmetry, density, de-center, in/out ratio, or any combination thereof, as non-limiting examples) used to determine the pixel value or intensity for that candidate location.

The second processor 304 is configured to process the candidate locations 340 and the score(s) 342 associated with each of the candidate locations 340 to generate a tracked position 306 of the drogue basket. For example, by obtaining candidate locations 340 and the scores 342 (e.g., confidence scores and sub-scores) for each of the candidate locations 340 that are generated by multiple detectors using independent detection techniques, the second processor 304 can achieve more robust tracking than is possible using only a single one of the detectors 330. In some implementations, the second processor 304 is configured to provide information associated with the tracked position 306, such as an updated range to the drogue basket and/or to the tanker, to the vision processor 302 for use by one or more of the detectors 330 and/or other components of the vision processor 302.

Although the vision processor 302 is depicted as including three detectors 330, in other implementations the vision processor 302 can have any number of detectors 330 (e.g., a single detector 330, two detectors 330, or four or more detectors 330) that can generate accumulation maps and provide candidate locations 340 and corresponding score(s) 342 to the second processor 304. In some implementations, one or more of the detectors 330A-330C may be omitted and/or replaced with one or more other types of detectors, one or more additional detectors may be added, or any combination thereof. For example, in some implementations, the vision processor 302 can include an active illumination detector that receives other image data 322, such as an infrared (IR) image captured by an infrared camera in conjunction with an IR emitter (e.g., a high-intensity, high-speed, narrow-band flash lamp such as an LED ring light) to detect a location of the basket via reflective markers, such as retro-reflective markers that may be intrinsic to the constriction of the drogue basket. According to an aspect, each of the detectors 330 is configured to generate an accumulation map (e.g., a probability map) and condense the accumulation map into an array of candidate locations and score values to be provided to the second processor 304.

In some implementations, the vision processor 302 is configured to perform annular histogramming that includes building a histogram of how much points at each given radial distance from the prospective center of the basket are aligned circularly around that center point, scoring the peaks of the histogram to indicate a confidence that the peak corresponds to an actual refueling basket, and providing an interpolated and/or refined estimate of the basket radius based on the histogram that can be used to refine the range to the basket and/or serve as state-based feedback for the next frame of the thermal image data.

Additionally, or alternatively, the vision processor 302 may be configured to estimate a refueling tanker pose based on an engine thermal signature in the thermal image 320. For example, the vision processor 302 may access geometric information regarding one or more engines of the tanker, detect the engine(s) in the thermal image 320 at least partially based in the temperature contrast between the engine exhaust and the ambient scene, and estimate the relative position of the tanker based on the extend and/or asymmetry of the detected engine(s). To illustrate, the thermal image 320 can be processed to detect engine-shaped regions of interest, a centroid and axis of each engine can be calculated and fit to a tanker model, and a geometric lever-arm conversion can be applied with the known ownship 6 degrees of freedom (6DoF) position to estimate the true tanker position.

Additionally, or alternatively, the vision processor 302 may be configured to estimate a refueling tanker pose based on rendering, at a GPU, a 2D image of the expected shadow of the 3D tanker position, such as using OpenGL, converting the shadow into a 2D expected tanker outline, and calculating the overlap between the expected 2D tanker outline and the gradient of the thermal image 320 to determine an overlap score. Such operations can be performed multiple times per incoming image frame (e.g., each thermal image 320) in order to track the movement of the tanker, refine the 6DoF pose of the tanker, and accurately track the tanker's 3D movements.

Although each of the detectors 330 is illustrated as included in the vision processor 302, in other implementations one or more of the detectors 330 is not included in the vision processor 302 and is instead external to both the vision processor 302 and the second processor 304 and is coupled to the vision processor 302, the second processor 304, or both.

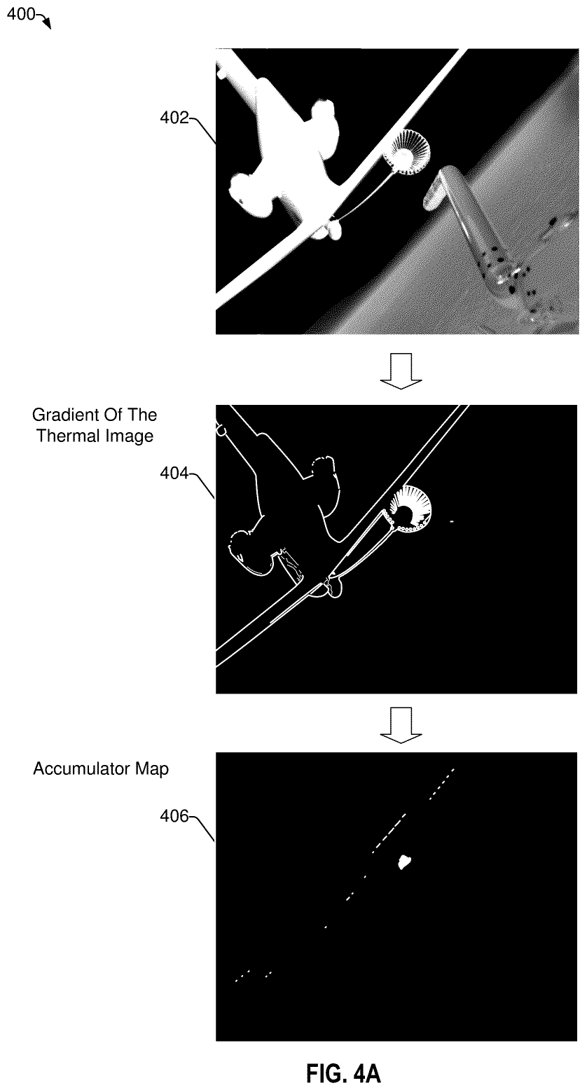

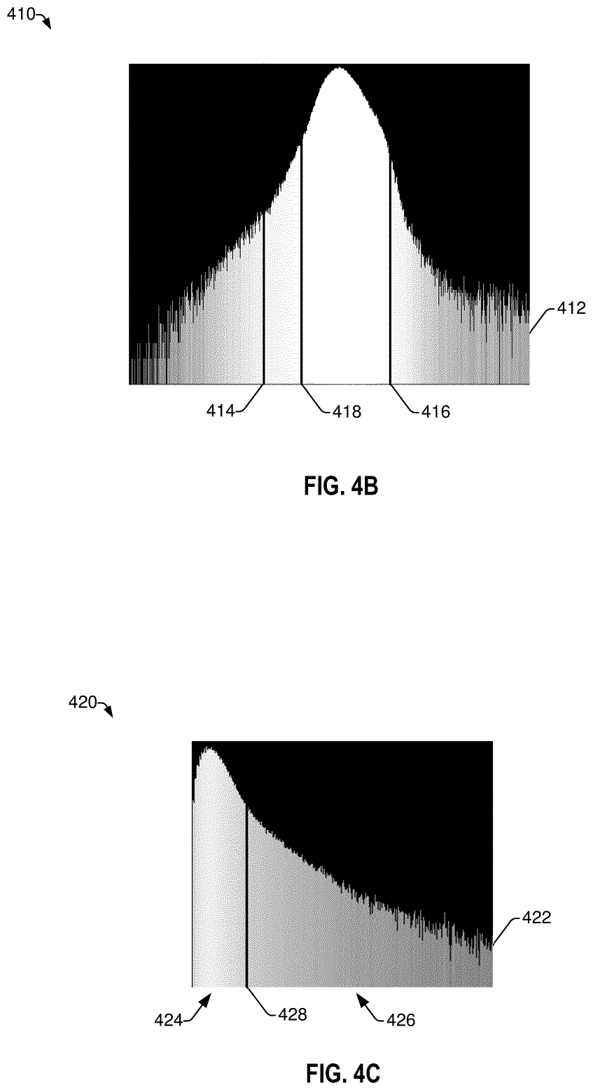

FIG. 4A depicts an example of a technique 400 to generate an accumulator map that may be performed by one or more of the detectors 330 of FIG. 3, such as the gradient-based spoke detector 330B. The technique 400 includes obtaining a thermal image 402 (e.g., the thermal image 320) that depicts at least a portion of a drogue. For example, the drogue may include or correspond to the drogue 114. In some implementations, the thermal image 402 includes an LWIR image captured by an LWIR camera.

The technique 400 also includes obtaining, based on the thermal image (e.g., the thermal image data), a gradient of at least a portion of the image. The gradient of an image can indicate a directional change in a temperature profile of a scene captured by a thermal image sensor (e.g., a thermal camera). In some implementations, the gradient of an image (or a portion of the image) is determined using an edge detection technique or an edge detector, such as a Sobel, Prewitt, Scharr, or other components from a Canny edge detector. For each pixel of the multiple pixels of the portion of the image, the gradient can include or indicate a value (e.g., a magnitude), a direction (e.g., an orientation of the magnitude), or a combination thereof. Additionally, the gradient can indicate or be used to determine an edge normal (e.g., a unit vector in the direction of maximum intensity change), and/or an edge direction (e.g., a unit vector along an edge and which is perpendicular to the edge normal). A representation of edge strength values (e.g., magnitudes) of the gradient of the thermal image 402 is shown at 404. In some implementations, obtaining the gradient includes performing one or more thresholding operations (e.g., one or more filtering operations) on the gradient. For example, the gradient can be filtered to remove points that have a weak gradient magnitude (e.g., have an intensity value that fails to satisfy a threshold) and/or are adjacent to points with a higher local maximum.

The technique 400 includes generating and/or populating an accumulator map 406 based on the gradient. The accumulator map 406 represents a probability map that any given pixel (e.g., point) in the thermal image 402 is a center of the drogue (e.g., a refueling basket). A resolution of the accumulator map 406 can correspond to a number of cells of the accumulator map 406, and a resolution of the thermal image 402 can include or correspond to a number of pixels of the thermal image 402 or of the portion of the thermal image 402. The accumulator map 406 can have a resolution that is less than or equal to a resolution of the thermal image 402 or a portion of the thermal image 402.

In some implementations, the vision processor 302 of FIG. 3 is configured to perform at least one of: thermal thresholding on the thermal image to identify pixels having intensity values that satisfy a thermal threshold or pair of thresholds, such as described with reference to FIG. 4B; and edge thresholding of an intensity gradient image that is based on the thermal image to detect edges associated with gradient magnitudes that satisfy an edge threshold, such as described with reference to FIG. 4C.

In FIG. 4B, a diagram 410 illustrates an example of an image histogram 412 of pixel values of the thermal image 320, with bins corresponding to thermal values on the X-axis (horizontal axis), and the height (the Y-axis) of each bin indicating the number of pixels in that bin. Vertical lines correspond to the probe temperature 418 (e.g., the temperature of the probe 106 of the first aircraft 102 of FIG. 1A, 1D, or 1E), a cold cut threshold 414, and a hot cut threshold 416. The vision processor 302 of FIG. 3 can perform a soft edge rejection using the thresholds 414, 416. Although the full dynamic range can be used to generate a binarized edge image, if an edge does not lie with 1 pixel of an image pixel within the thresholded range between the cold cut threshold 414 and the hot cut threshold 416, the edge is excluded as coming from an object that is entirely too hot or cold to be the drogue. This allows detection of the drogue edges even when in front of hot or cold backgrounds. In some implementations, one or both of the thresholds 414, 416 may be dynamically adjusted to improve robustness of the drogue detection.

In FIG. 4C, a diagram 420 illustrates an example of an edge histogram 422 (e.g., a raw edge strength map) of edge values corresponding to a gradient of the thermal image 320 (e.g., corresponding to the gradient of the thermal image 404), with bins corresponding to gradient magnitudes on the X-axis (horizontal axis) and the height (the Y-axis) of each bin indicating the number of pixels associated with a gradient magnitude in that bin. A threshold 428 represented by a vertical line corresponds to a current edge threshold, with weaker edges 424 on the left, and stronger edges 426 on the right. The vision processor 302 of FIG. 3 can perform edge thresholding using the threshold 428, keeping the strong edges 426 and discarding (or masking, or otherwise preventing use of) the weaker edges 424. Edge thresholding improves efficiency and accuracy in detection of the drogue edges. In some implementations the threshold 428 may be dynamically adjusted, such as to keep a fixed number of edge pixels, to improve robustness of the drogue detection.

The system 300 of FIG. 3, when used in conjunction with a receiver aircraft, such as the first aircraft 102 of FIG. 1A, 1D, or 1E, enables integration of multiple technologies into a complete thermal camera (e.g., LWIR)-based sensor system, which can be implemented without the use of artificial intelligence (AI)/machine learning (ML) components. Proving such capability without the use of AI/ML avoids potential hurdles to certification due to the difficulty fully characterizing and validating a non-deterministic solution based on AI/ML.

According to some aspects, given a receiver aircraft outfitted with at least one forward-looking LWIR camera and a tanker aircraft with an aerial refueling basket, along with a computer system (e.g., the vision processor 302) that is capable of real time processing of the LWIR images and a separate computer system (e.g., the second processor 304) capable of real time post-processing of the candidate detections at high level of rigor, the disclosed techniques enable real time location of aerial refueling drogue using thermal imaging. An estimate of the radius of the basket to be detected may also be used in conjunction with the disclosed techniques, and may be based on one or more of: feed-forward, GPS based relative positioning, and/or computer vision-based tracking of the tanker.

According to an aspect, a substantial portion of the thermal image frame is used to perform detection of the aerial refueling basket, providing improved situational awareness as compared to just performing object tracking. A system implementing the present techniques can combine one or more computer vision based object-detection algorithms to produce a variety of semi-independent solutions, such as the various sets of candidate locations 340 of FIG. 3, and can provide one or more candidate object-detections with scoring and meta-scoring (e.g., the score(s) 342) for each detection that can be used by downstream track correlation processes to perform the tracking at a later stage. The basket position and range can be determined with sub-pixel resolution, and the basket confidence can be refined with information about the camera-observed relative temperature of the basket as compared to the expected relative temperature of the basket. In addition, a separate high level of rigor computer system (e.g., the second processor 304) can be used to calculate the final guidance control point based on the data provided by the sensor system's intermediate outputs from processing the LWIR image(s) (e.g., the output of the vision processor 302 generated from processing the thermal image 320).

For example, in accordance with various implementations, the gradient (magnitude and angle) of the LWIR image is calculated, and hot/cold clipping (e.g., as described in FIG. 4B) of the scene and/or thresholding used to isolate gradient edges (e.g., as described in FIG. 4C) are dynamically adjusted using general awareness of the relative temperatures of the scene, as provided by the LWIR camera and reference objects in the camera foreground and/or measurements taken from the additional sensors 110 if present.

According to some aspects, one or more of the following techniques are used to detect the aerial refueling basket: Hough Gradient-based circle detection of the outer basket skirt; Gradient-Based spoke detection of the inner basket spokes; FFT based Phase Correlation Template Matching/detection of the basket; and/or FFT based Convolutional Template Matching/detection of the basket. The internal accumulator map outputs of any computer vision operation (e.g., performed at the detectors 330) can be condensed into a list of candidate basket locations (e.g., the candidate locations 340). In some implementations, for each candidate location, the present techniques provide not only a score but also the individual sub scores that went into calculation of that score. These candidate detections and scores are transferred to a second computer system that operates at a higher level of rigor to perform track-state-management and determines the final tracked position that is used for guidance and control of the receiver aircraft.

Thus, implementations of the present disclosure include a system that uses a LWIR camera and an image processing system to calculate the image gradient magnitude and direction. In addition to the 2D image from the LWIR camera, the system can also use relative temperature information (either gleaned from an external temperature measurement, or from LWIR imagery of a reference object in the video frame). Further, two or more isolated computing environments can be used to segregate the image processing from the high level of rigor track state management.

According to some aspects, the present techniques provide benefits such as full frame detection in real time at 60 Hertz without the aid of Artificial Intelligence or Machine Learning (AI/ML). The present techniques include layering of multiple semi-independent solutions to independently score the probability of the drogue being located at a given point, and a system implementing such techniques can operate as a sensor system and provide these candidate locations, their scores, and the meta-scores that went into the scoring to a downstream system that operates at a higher level of rigor in order to make the actual determination of the point to be tracked. By avoiding AI/ML and segregating track state management to a second computer environment operating at a higher level of rigor, the present techniques provide a certifiable solution for autonomism aerial refueling receive while avoiding many of the pitfalls that could cause an otherwise functional system to fail to meet various certification criteria for close-formation manned/unmanned flight.

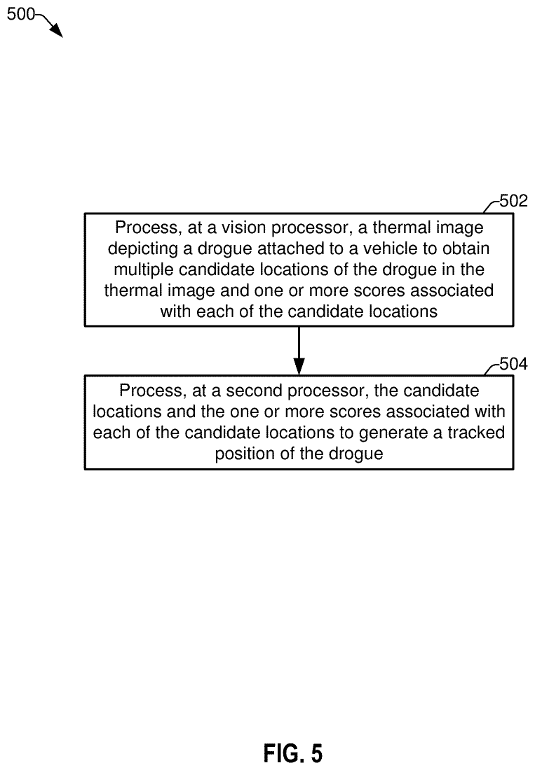

FIG. 5 is a flowchart that illustrates an example of a method 500 of performing thermal image-based tracking to mate connectors of vehicles according to one or more aspects of the present disclosure. The method 500 can be initiated, performed, or controlled by one or more processors executing instructions, or by circuitry configured to cause performance of one or more operations, such as the vision processor 302, the second processor 304, or both, that may be implemented in the first aircraft 102 of FIG. 1A, 1D, or 1E (e.g. the vision processor 108 and the additional processor(s) 111) or the vision processor 204 and the guidance processor 208 of FIG. 2, or a combination thereof.

The method 500 includes, at block 502, processing, at a vision processor, a thermal image depicting a drogue (e.g., a drogue basket) attached to a vehicle to obtain multiple candidate locations of the drogue in the thermal image and one or more scores associated with each of the candidate locations. For example, the vision processor 302 of FIG. 3 generates the multiple candidate locations 340 and the score(s) 342 associated with each of the candidate locations.

The method 500 includes, at block 504, processing, at a second processor, the candidate locations and the one or more scores associated with each of the candidate locations to generate a tracked position of the drogue. For example, the second processor 304 of FIG. 3 processes the multiple candidate locations 340 and the score(s) 342 associated with each of the candidate locations to generate a tracked position of the drogue.

In some implementations, the method 500 can include more, fewer, and/or different steps without departing from the scope of the subject disclosure. The method 500 can be implemented to realize one or more of the technical advantages described in more detail above.

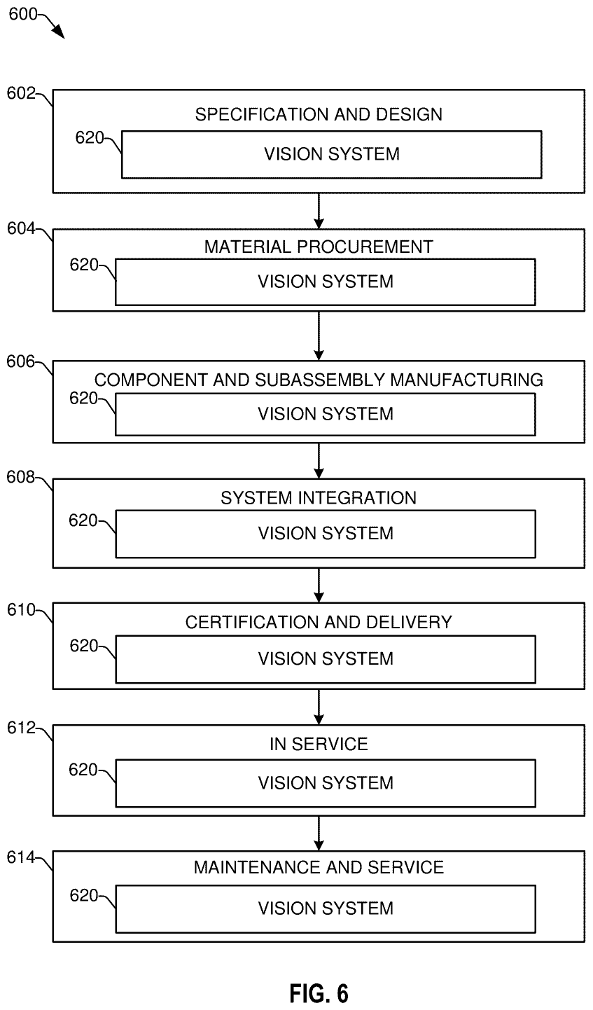

Referring to FIG. 6, a flowchart illustrative of an example of a life cycle of an aircraft that includes a vision system configured to perform thermal image-based tracking to mate connectors of vehicles is shown and designated 600. During pre-production, the exemplary method 600 includes, at 602, specification and design of an aircraft, such as the first aircraft 102 described with reference to FIG. 1A, 1D, or 1E. During specification and design of the aircraft, the method 600 can include specification and design of a vision system 620 that is configured to perform thermal image-based pose tracking to mate connectors of vehicles. The vision system 620 may include one or more components of the system 100 of FIG. 1A (e.g., the thermal imaging sensor 104, the vision processor 108, and/or the one or more additional processor(s) 111), the system 200 of FIG. 2, and/or the system 300 of FIG. 3 (e.g., the vision processor 302 and/or the second processor 304). At 604, the method 600 includes material procurement, which can include procuring materials for the vision system 620.

During production, the method 600 includes, at 606, component and subassembly manufacturing and, at 606, system integration of the aircraft. For example, the method 600 can include component and subassembly manufacturing of the vision system 620 and system integration of the vision system 620. At 610, the method 600 includes certification and delivery of the aircraft and, at 612, placing the aircraft in service. Certification and delivery can include certification of the vision system 620 to place the vision system 620 in service. While in service by a customer, the aircraft can be scheduled for routine maintenance and service (which can also include modification, reconfiguration, refurbishment, and so on). At 614, the method 600 includes performing maintenance and service on the aircraft, which can include performing maintenance and service on the vision system 620.

Each of the processes of the method 600 can be performed or carried out by a system integrator, a third party, and/or an operator (e.g., a customer). For the purposes of this description, a system integrator can include without limitation any number of aircraft manufacturers and major-system subcontractors; a third party can include without limitation any number of venders, subcontractors, and suppliers; and an operator can be an airline, leasing company, military entity, service organization, and so on.

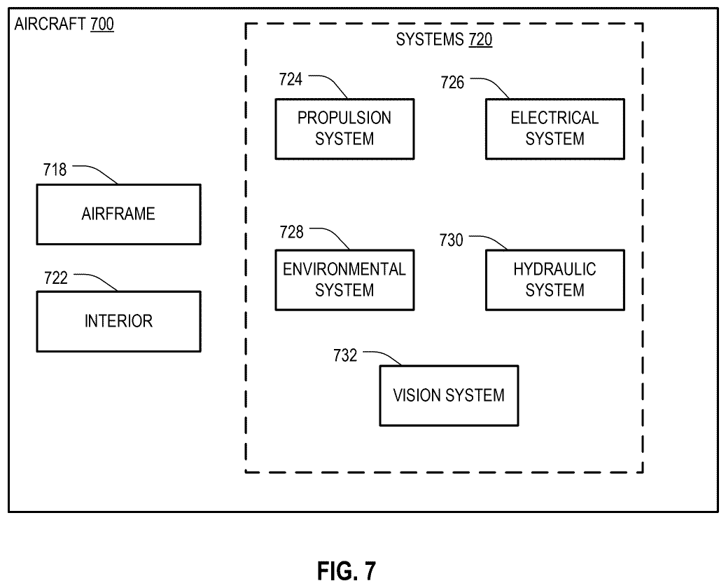

Aspects of the disclosure can be described in the context of an example of a vehicle. A particular example of a vehicle is an aircraft 700 as shown in FIG. 7. The aircraft 700 can be a drone aircraft or any type of autonomous or semi-autonomous aircraft or spacecraft. In the example of FIG. 7, the aircraft 700 includes an airframe 718 with a plurality of systems 720 and an interior 722. Examples of the plurality of systems 720 include one or more of a propulsion system 724, an electrical system 726, an environmental system 728, a hydraulic system 730, and a vision system 732. Any number of other systems can be included and/or one or more of the systems depicted in FIG. 7 may be omitted. In the example of FIG. 7, the vision system 732 is configured to provide thermal image-based tracking functionality to mate connectors of vehicles and can include or correspond to the system 100 of FIG. 1A, the system 200 of FIG. 2, the system 300 of FIG. 3, the vision system 620 of FIG. 6, or any combination thereof.

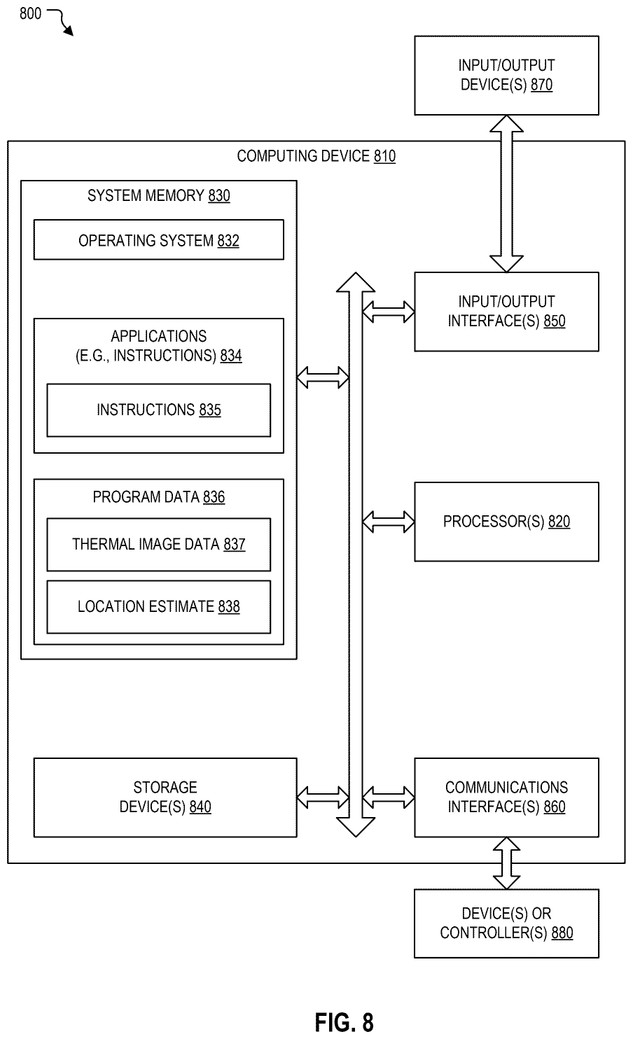

FIG. 8 is a block diagram of a computing environment 800 including a computing device 810 configured to support aspects of computer-implemented methods and computer-executable program instructions (or code) according to the present disclosure. For example, the computing device 810, or portions thereof, is configured to execute instructions to initiate, perform, or control one or more operations described with reference to FIGS. 1-7.

The computing device 810 includes one or more processors 820. The processor(s) 820 are configured to communicate with system memory 830, one or more storage devices 840, one or more input/output interfaces 850, one or more communications interfaces 860, or any combination thereof. The system memory 830 includes volatile memory devices (e.g., random access memory (RAM) devices), nonvolatile memory devices (e.g., read-only memory (ROM) devices, programmable read-only memory, and flash memory), or both. The system memory 830 stores an operating system 832, which can include a basic input/output system for booting the computing device 810 as well as a full operating system to enable the computing device 810 to interact with users, other programs, and other devices. The system memory 830 stores system (program) data 836, such as thermal image data 837, a location estimate 838, or a combination thereof. The thermal image data 837 can include or correspond to thermal image data generated by the thermal imaging sensor 104 of FIG. 1A, 1D, or 1E or the LWIR camera 202 of FIG. 2. The location estimate 838 can include or correspond to one or more of the candidate locations 340 of FIG. 3, tracked position 306 of the drogue basket computed by the second processor 304 based at least in part on the candidate locations 340 and score(s) 342 of FIG. 3, or a combination thereof.

The system memory 830 includes one or more applications 834 (e.g., sets of instructions) executable by the processor(s) 820. As an example, the one or more applications 834 include instructions executable by the processor(s) 820 to initiate, control, or perform one or more operations described with reference to FIGS. 1-8. To illustrate, the one or more applications 834 include instructions 835 executable by the processor(s) 820 to initiate, control, or perform one or more operations described with reference to the vision processor 108 of FIG. 1A, the additional processor(s) 111, the vision processor 204 of FIG. 2, the guidance processor 208, the vision processor 302 of FIG. 3, the second processor 304, or a combination thereof.

In a particular implementation, the system memory 830 includes a non-transitory, computer readable medium storing the instructions 835 that, when executed by the processor(s) 820, cause the processor(s) 820 to initiate, perform, or control operations to perform thermal image-based tracking functionality to mate connectors of vehicles. The operations include processing, at a first processor (e.g., the vision processor 302), a thermal image depicting a drogue attached to a vehicle to obtain multiple candidate locations of the drogue in the thermal image and one or more scores associated with each of the candidate locations. The instructions, when executed, also cause a second processor (e.g., the second processor 304) to perform operations including processing the candidate locations and the one or more scores associated with each of the candidate locations to generate a tracked position of the drogue.

The one or more storage devices 840 include nonvolatile storage devices, such as magnetic disks, optical disks, or flash memory devices. In a particular example, the storage devices 840 include both removable and non-removable memory devices. The storage devices 840 are configured to store an operating system, images of operating systems, applications (e.g., one or more of the applications 834), and program data (e.g., the system program data 836). In a particular aspect, the system memory 830, the storage devices 840, or both, include tangible computer-readable media. In a particular aspect, one or more of the storage devices 840 are external to the computing device 810.

The one or more input/output interfaces 850 enable the computing device 810 to communicate with one or more input/output devices 870 to facilitate user interaction. For example, the one or more input/output interfaces 850 can include a display interface, an input interface, or both. For example, the input/output interface 850 is adapted to receive input from a user, to receive input from another computing device, or a combination thereof. In some implementations, the input/output interface 850 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 870 includes one or more user interface devices and displays, including some combination of buttons, keyboards, pointing devices, displays, speakers, microphones, touch screens, and other devices.

The processor(s) 820 are configured to communicate with devices or controllers 880 via the one or more communications interfaces 860. For example, the one or more communications interfaces 860 can include a network interface. The devices or controllers 880 can include, for example, a controller for the probe 106, one or more other devices, or any combination thereof.

In some implementations, a non-transitory, computer readable medium stores instructions that, when executed by one or more processors, cause the one or more processors to initiate, perform, or control operations to perform part or all of the functionality described above. For example, the instructions can be executable to implement one or more of the operations or methods of FIGS. 1-8. In some implementations, part or all of one or more of the operations or methods of FIGS. 1-8 can be implemented by one or more processors (e.g., one or more central processing units (CPUs), one or more graphics processing units (GPUs), one or more digital signal processors (DSPs), one or more field-programmable gate arrays (FPGAs), or one or more application-specific integrated circuits (ASICs)) executing instructions, by dedicated hardware circuitry, or any combination thereof.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Aspects of the disclosure are described further with reference to the following set of interrelated examples:

According to Example 1, a device includes a thermal imaging sensor configured to generate a thermal image depicting a drogue attached to a vehicle; a vision processor coupled to the thermal imaging sensor, wherein the vision processor is configured to process the thermal image to obtain multiple candidate locations of the drogue in the thermal image and one or more scores associated with each of the candidate locations; and a second processor configured to process the candidate locations and the one or more scores associated with each of the candidate locations to generate a tracked position of the drogue.

Example 2 includes the device of Example 1, wherein the vision processor is configured to generate a first set of the candidate locations based on a first image processing operation and a second set of the candidate locations based on a second image processing operation that is distinct from the first image processing operation.

Example 3 includes the device of Example 1 or Example 2, wherein the first image processing operation includes at least one of a gradient-based circle detection of an outer edge of a drogue basket, a gradient-based spoke detection of inner spokes of the drogue basket, or a transform-based template matching detection of the drogue basket.

Example 4 includes the device of Example 3, wherein the second image processing operation includes another of the gradient-based circle detection of the outer edge of the drogue basket, the gradient-based spoke detection of the inner spokes of the drogue basket, or the transform-based template matching detection of the drogue basket.

Example 5 includes the device of any of Examples 1 to 4, wherein the vision processor is configured to perform thermal thresholding on the thermal image to identify pixels having intensity values that satisfy a thermal threshold.

Example 6 includes the device of any of Examples 1 to 5, wherein the vision processor is configured to perform edge thresholding of an intensity gradient image that is based on the thermal image to detect edges associated with gradient magnitudes that satisfy an edge threshold.

Example 7 includes the device of any of Examples 1 to 6, wherein at least one of the one or more scores associated with each of the candidate locations corresponds to a confidence value for a candidate location.

Example 8 includes the device of any of Examples 1 to 7, wherein the second processor is configured to provide information associated with the tracked position of the drogue to the vision processor.

Example 9 includes the device of Example 8, wherein the information associated with the tracked position includes at least one of an updated range to the drogue or an updated range to the vehicle.

Example 10 includes the device of any of Examples 1 to 9, wherein the vision processor includes multiple detectors, and wherein at least one of the multiple detectors is configured to process the thermal image to generate an accumulation map, processed thermal image data, score values, or a combination thereof, corresponding to one or more of the candidate locations.

According to Example 11, a method includes receiving, at a vision processor of a device, a thermal image depicting a drogue attached to a vehicle; processing, at the vision processor, the thermal image to obtain multiple candidate locations of the drogue in the thermal image and one or more scores associated with each of the candidate locations; and processing, at a second processor of the device, the candidate locations and the one or more scores associated with each of the candidate locations to generate a tracked position of the drogue.

Example 12 includes the method of Example 11, wherein processing the thermal image to obtain multiple candidate locations includes generating, at the vision processor, a first set of the candidate locations based on a first image processing operation and a second set of the candidate locations based on a second image processing operation that is distinct from the first image processing operation.

Example 13 includes the method of Example 11 or Example 12, wherein the first image processing operation includes at least one of a gradient-based circle detection of an outer edge of a drogue basket, a gradient-based spoke detection of inner spokes of the drogue basket, or a transform-based template matching detection of the drogue basket.

Example 14 includes the method of Example 13, wherein the second image processing operation includes another of the gradient-based circle detection of the outer edge of the drogue basket, the gradient-based spoke detection of the inner spokes of the drogue basket, or the transform-based template matching detection of the drogue basket.

Example 15 includes the method of any of Examples 11 to 14 and further includes performing, at the vision processor, thermal thresholding on the thermal image to identify pixels having intensity values that satisfy a thermal threshold.

Example 16 includes the method of any of Examples 11 to 15 and further includes performing, at the vision processor, edge thresholding of an intensity gradient image that is based on the thermal image to detect edges associated with gradient magnitudes that satisfy an edge threshold.

According to Example 17, a non-transitory, computer readable medium storing instructions that, when executed by one or more processors that include a vision processor and a second processor, cause the one or more processors to perform operations that include receiving, at the vision processor, a thermal image depicting a drogue attached to a vehicle; processing, at the vision processor, the thermal image to obtain multiple candidate locations of the drogue in the thermal image and one or more scores associated with each of the candidate locations; and processing, at the second processor, the candidate locations and the one or more scores associated with each of the candidate locations to generate a tracked position of the drogue.

Example 18 includes the non-transitory, computer readable medium of Example 17, wherein the operations further include generating, at the vision processor, a first set of the candidate locations based on a first image processing operation and a second set of the candidate locations based on a second image processing operation that is distinct from the first image processing operation.

Example 19 includes the non-transitory, computer readable medium of Example 17 or Example 18, wherein the first image processing operation includes at least one of a gradient-based circle detection of an outer edge of a drogue basket, a gradient-based spoke detection of inner spokes of the drogue basket, or a transform-based template matching detection of the drogue basket.

Example 20 includes the non-transitory, computer readable medium of Example 19, wherein the second image processing operation includes another of the gradient-based circle detection of the outer edge of the drogue basket, the gradient-based spoke detection of the inner spokes of the drogue basket, or the transform-based template matching detection of the drogue basket.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. A device comprising:
a thermal imaging sensor configured to generate a thermal image depicting a drogue attached to a vehicle;
a vision processor coupled to the thermal imaging sensor, wherein the vision processor is configured to process the thermal image to obtain multiple candidate locations of the drogue in the thermal image and one or more scores associated with each of the candidate locations; and
a second processor configured to process the candidate locations and the one or more scores associated with each of the candidate locations to generate a tracked position of the drogue.

2. The device of claim 1, wherein the vision processor is configured to generate a first set of the candidate locations based on a first image processing operation and a second set of the candidate locations based on a second image processing operation that is distinct from the first image processing operation.

3. The device of claim 2, wherein the first image processing operation includes at least one of a gradient-based circle detection of an outer edge of a drogue basket, a gradient-based spoke detection of inner spokes of the drogue basket, or a transform-based template matching detection of the drogue basket.

4. The device of claim 3, wherein the second image processing operation includes another of the gradient-based circle detection of the outer edge of the drogue basket, the gradient-based spoke detection of the inner spokes of the drogue basket, or the transform-based template matching detection of the drogue basket.

5. The device of claim 1, wherein the vision processor is configured to perform thermal thresholding on the thermal image to identify pixels having intensity values that satisfy a thermal threshold.

6. The device of claim 1, wherein the vision processor is configured to perform edge thresholding of an intensity gradient image that is based on the thermal image to detect edges associated with gradient magnitudes that satisfy an edge threshold.

7. The device of claim 1, wherein at least one of the one or more scores associated with each of the candidate locations corresponds to a confidence value for a candidate location.

8. The device of claim 1, wherein the second processor is configured to provide information associated with the tracked position of the drogue to the vision processor.

9. The device of claim 8, wherein the information associated with the tracked position includes at least one of an updated range to the drogue or an updated range to the vehicle.

10. The device of claim 1, wherein the vision processor includes multiple detectors, and wherein at least one of the multiple detectors is configured to process the thermal image to generate an accumulation map, processed thermal image data, score values, or a combination thereof, corresponding to one or more of the candidate locations.

11. A method comprising:
receiving, at a vision processor of a device, a thermal image depicting a drogue attached to a vehicle;
processing, at the vision processor, the thermal image to obtain multiple candidate locations of the drogue in the thermal image and one or more scores associated with each of the candidate locations; and
processing, at a second processor of the device, the candidate locations and the one or more scores associated with each of the candidate locations to generate a tracked position of the drogue.

12. The method of claim 11, wherein processing the thermal image to obtain multiple candidate locations includes generating, at the vision processor, a first set of the candidate locations based on a first image processing operation and a second set of the candidate locations based on a second image processing operation that is distinct from the first image processing operation.

13. The method of claim 12, wherein the first image processing operation includes at least one of a gradient-based circle detection of an outer edge of a drogue basket, a gradient-based spoke detection of inner spokes of the drogue basket, or a transform-based template matching detection of the drogue basket.

14. The method of claim 13, wherein the second image processing operation includes another of the gradient-based circle detection of the outer edge of the drogue basket, the gradient-based spoke detection of the inner spokes of the drogue basket, or the transform-based template matching detection of the drogue basket.

15. The method of claim 11, further comprising performing, at the vision processor, thermal thresholding on the thermal image to identify pixels having intensity values that satisfy a thermal threshold.

16. The method of claim 11, further comprising performing, at the vision processor, edge thresholding of an intensity gradient image that is based on the thermal image to detect edges associated with gradient magnitudes that satisfy an edge threshold.

17. A non-transitory, computer readable medium storing instructions that, when executed by one or more processors that include a vision processor and a second processor, cause the one or more processors to perform operations comprising:
receiving, at the vision processor, a thermal image depicting a drogue attached to a vehicle;
processing, at the vision processor, the thermal image to obtain multiple candidate locations of the drogue in the thermal image and one or more scores associated with each of the candidate locations; and
processing, at the second processor, the candidate locations and the one or more scores associated with each of the candidate locations to generate a tracked position of the drogue.

18. The non-transitory, computer readable medium of claim 17, wherein the operations further include generating, at the vision processor, a first set of the candidate locations based on a first image processing operation and a second set of the candidate locations based on a second image processing operation that is distinct from the first image processing operation.

19. The non-transitory, computer readable medium of claim 18, wherein the first image processing operation includes at least one of a gradient-based circle detection of an outer edge of a drogue basket, a gradient-based spoke detection of inner spokes of the drogue basket, or a transform-based template matching detection of the drogue basket.

20. The non-transitory, computer readable medium of claim 19, wherein the second image processing operation includes another of the gradient-based circle detection of the outer edge of the drogue basket, the gradient-based spoke detection of the inner spokes of the drogue basket, or the transform-based template matching detection of the drogue basket.
